(19) United States
(12) Patent Application Publication
(10) Pub. No.: US 2007/0256545 A1
(43) Pub. Date: Nov. 8, 2007

(54) Portable Moving-Picture Multimedia Player and Microphone-type Apparatus for Accompanying Music Video

(75) Inventors: Ki-Un Lee, Seoul (KR); Sack Lee, Seoul (KR)

Correspondence Address: CANTOR COLBURN, LLP, 55 GRIFFIN ROAD SOUTH, BLOOMFIELD, CT, 06002, US

(73) Assignee: Ki-Un LEE, Seoul (KR)

(21) Appl. No.: 11/577,623

(22) PCT Filed: Oct. 19, 2005
(86) PCT No.: PCT/KR05/03477

§ 371 Date: Apr. 20, 2007

(30) Foreign Application Priority Data
Oct. 20, 2004 (KR) 1020040083990

(51) Int. Cl. G10H 1/36

(52) U.S. Cl. 84/610

(57) ABSTRACT

Disclosed are a portable multimedia player detachably coupled in a microphone case and a microphone-type video-song accompaniment apparatus. The apparatus includes a microphone case and a portable moving picture multimedia player. The microphone case has a head part in which an external microphone is installed, a grip part having a coupling groove, and a microphone connection terminal, an audio line terminal and a video line terminal formed in the coupling groove. The portable moving picture multimedia player has connection terminals formed on an outer circumference thereof to electrically contact the microphone connection terminal, the audio line terminal and the video line terminal, switches the external microphone and an internal microphone in response to coupling or decoupling thereof, operates in a video-song accompaniment mode when coupled, and operates in a portable multimedia player mode when decoupled.

### TECHNICAL FIELD

The present invention relates to a portable moving-picture multimedia player and a microphone-type apparatus for accompanying a music video, and particularly, to an apparatus in which a portable moving-picture multimedia player is built in a microphone case to provide a television with a background picture including a moving picture and a still picture together with accompaniment such that people can sing a song together with the background picture.

### BACKGROUND ART

The present inventor is also an inventor of Korean Patent No. 10-0093362 entitled with “Automatic accompanying apparatus-built in Microphone”, Korean Patent Publication No. 1997-68724 entitled with “Microphone outputting images/song lyrics information and accompaniment” and Korean Patent No. 10-295271 entitled with “Microphone for automatic accompaniment and image output control and receiver for generation of image/caption.

Microphone-type image/song accompanying apparatus includes an image/song accompanying device built in a microphone case such that the image/song accompanying device and the microphone are integrated with each other. The microphone-type image/song accompanying apparatus outputs a background picture, an accompaniment and lyrics by connecting the microphone with a television set through a line or by a wireless communication way such that people can enjoy the image, song and accompaniment.

The microphone disclosed in U.S. Pat. No. 295,271 outputs the accompaniment and voice but does not output an image. When the microphone generates and outputs an image output control signal and a caption control signal, a television set displays an image and a caption corresponding to an accompanying song in response to the control signals on a screen thereof. The above microphone is so designed because it has a limitation in storing image data requiring a large memory capacity.

The prior art microphone-type song accompaniment apparatus is a small size corresponding to that of the microphone, but has a limitation of place in its use. In other words, it can be used in places where a box-shaped case is installed, for example, a home, a singing room, a vehicle and the like. Also, the prior art microphone-type song accompaniment apparatus is inconvenient owing to a large volume microphone and is also inconvenient in carrying it.

In general, to store live music of a singer in a compact disc (CD), a data capacity of about 1.41 Mbps (=44.1 kHz 16 bit 2 ch) (176 kB) is required. Accordingly, when it is assumed that one song takes four minutes, a total of 338.4 Mb (=1.41 Mbps 240 sec) (42.3 MB) is required. An MP3 file whose audio data corresponding to the sound quality of CD is compressed in a compression rate of 1/12 can be stored in the capacity of 3.525 MB.

Hence, in order to store about 5,000 accompaniment files in the format of MP3 files, 17.625 GB memory capacity is required. To this end, if the song accompaniment apparatus is made in the storing way of MP3 files, burdens to miniaturization and high production costs may be caused. In case a hard disc is used as a storage unit instead of a memory chip, problems related with the power consumption, the stability against a physical impact, and the product miniaturization may be caused.

In addition, to support the background picture in the song accompaniment, background picture data should be also stored in the apparatus. When a color moving picture and a still picture having a size of 7204808 bits is stored in R, G, B data, 8.29 Mb (=7204808 bits) (RGB) storage capacity is required.

Therefore, such a high memory capacity makes it difficult to realize a portable song accompaniment apparatus product capable of storing a few hundreds of image song accompaniment files and their background picture files.

### DISCLOSURE

### Technical Problem

The present invention has been devised to solve the above prior art problems.

An object of the present invention is to provide a portable moving-picture multimedia player that is convenient to carry due to a compact size, can enjoy a few hundreds of moving picture song accompaniment whenever a user wishes, and can play data downloaded from a computer.

Another object of the present invention to provide a portable moving-picture multimedia player that is detachably coupled in a microphone case.

Still another object of the present invention is to provide a microphone-type song accompaniment apparatus configured in a microphone type when a detachable portable moving picture multimedia player and a microphone case are coupled.

### TECHNICAL SOLUTION

To accomplish the above objects, there is provided a portable moving picture multimedia player having a housing detachable in a microphone case and having a portable size. In the housing, an internal microphone, a plurality of connection terminals installed on an outer circumference of the housing so as to be electrically connected with an external microphone, an audio line and a video line, a liquid crystal display unit for displaying lyric information of selected songs and menu information, a user interface for inputting a user command, a computer interface installed in the housing, for interfacing uploading/downloading of data to/from a computer, a non-volatile storage unit having a storage space for storing a few thousands of compressed video music files and compressed background picture files and storing data file downloaded or provided from the computer or an exterior, an audio codec installed in the housing, for converting input audio data into an analog audio signal, mixing the converted audio signal with a voice signal inputted through the external or internal microphone to create an output audio signal, and converting the input voice signal into a digital audio data, a video codec installed in the housing, for creating a television complex video signal from an input video data and a caption data and a video data from an input video signal, and a controller are installed.

The controller detects whether the microphone case is coupled or decoupled to control a switching of the external and internal microphones. When the microphone case is coupled, the controller accesses a video music file selected from the non-volatile storage unit in response to a user command and decompresses the compressed audio data and provides the decompressed video music file to the audio codec, decompresses the compressed background picture and provides the decompressed background picture to the video codec to execute a video music accompaniment mode. When the microphone case is decoupled, the controller executes a video music accompaniment play mode, a computer data play/record mode and a computer data up/down mode.

The compressed video music files includes: a voice data that a voice of a singer corresponding to the music is converted into a digital data and compressed; an accompaniment data that sounds of musical instruments for the music are created in MIDI data and compressed; a lyric data; and a video control data for accessing the background pictures related with the lyric, atmosphere and genre of the music.

Herein, the voice data is a data that a voice signal of a singer is compressed.

Preferably, the voice signal of the singer is converted into 16 bits audio data (704 kbps=22 kHz 16 bit) using 22 kHz of sampling frequency, and the converted audio data is compressed at a rate of 12 kbps per second, for example, by a compressive algorithm of audio standard G726 to G729. Accordingly, in the case of a music having four minutes length, the voice signal of the singer is compressed in a data of approximately 360 kB (−12 kbps 240 sec/8 bit). Herein, the compressive algorithm of the audio data is applicable from a variety of algorithms within the same scope.

The accompaniment data is a data that sounds of musical instruments for a song are created in MIDI data and the created MIDI data is compressed. Preferably, a MIDI data of 16 channels (sixteentet) and four minutes has the data amount of about 45 kB. This MIDI data is compressed in approximately 13 kB or so using a lossless compression, for example, a compressive algorithm, such as ZIP, LHA or the like compressing computer data.

Accordingly, the video-song accompaniment file includes about 373 kB data corresponding to a voice, and about 400 kB data corresponding to musical instrument data, lyric data and video control data. For example, 5,000 songs require a storage space of 2 Gb. Hence, the video-song accompaniment files have a data compression rate 9 times as much as that of MP3 files of 5000 songs, and a data compression rate 106 times as much as that of the original signals.

At the present, since a commercialized flash memory has about 2 GB storage capacity, the present invention can realize a portable multimedia apparatus capable of storing 5,000 songs.

The background picture file includes a moving picture file and a still picture file. Preferably, in the case of the moving picture, an RGB color data having the size of 720480 is made in a moving picture file having a data amount of 512 kbps by applying an MPEG4 compression way.

For example, the size of a moving picture file corresponding to about 1 minute may be made in about 3.8 MB. In the case of the still picture, it has a data amount of about 40 kB by the MPEG4 compression way. Accordingly, when a background picture file is made using 100 moving picture files each having a play time of 1 minute and 1000 still picture files, the background picture occupies the storage space of about 420 MB (=380 MB+40 MB). Accordingly, it is possible to properly design the size of the storage space using a combination of a few thousands of video-song accompaniment files and a few thousands of background picture files.

For example, when the moving picture song accompaniment apparatus is made including 3,000 songs of video-song accompaniment files, about 100 moving picture files each having about 1 minute play time, and 1,000 still picture files, a total of 1.62 GB storage space is required. If the storage space is made in a flash card of 2 GB, a marginal space of about 380 MB remains.

Herein, 2 GB is only one example. Hence, it is possible to develop a variety of models having a few GB storage capacity depending on the storage capacity of a memory card or a memory device mountable in a portable moving picture multimedia player.

In the present invention, this marginal space is provided as a storage space for data files. Accordingly, in the marginal space, about 95 MP3 files each having the size of 4 MB and a moving picture having the size of 100 minutes can be stored. In addition, a handheld semiconductor storage device capable of storing other voice record data, photograph image data and computer files can be provided.

In the present invention, the data files that can be uploaded/downloaded to/from a computer may include any one selected from the group consisting of an MP3 music file, a voice recording file, a digital photograph image file and a combination thereof.

In the present invention, the non-volatile storage unit may be any one selected from the group consisting of an EEPROM, a flash memory, a flash memory card, a mini hard disc driver and a combination thereof. Preferably, a flash memory card that is exchangeable and has a strong endurability against an impact is used.

In the present invention, the computer intefacecomputer inteface key installed in the housing, a jog dial having a dial and a pushing button combined with the dial, a mode selection key for selecting a song selection menu mode, and a play key for starting or stopping a selected song to minimize the digits of the key pads. Hence, the production costs are reduced and convenience in use is enhanced.

When the song selection menu mode is selected by the mode selection key, a song number is scrolled and displayed. When a song title list selection menu mode is selected, desired songs are rapidly selected by moving a cursor on the title list displayed by an up/down dialing of the jog dial.

Preferably, the pushing button of the jog dial allows the cursor to be moved along digit positions of a song number whenever the pushing button is pushed in the song number selection menu mode, and allows pages of a title list to be converted whenever the pushing button is pushed in the song title list selection menu mode.

Preferably, the player further comprises a vibration motor installed in the housing, and the controller controls the vibration motor such that the housing vibrates in response to a rhythm of a selected song accompaniment. Hence, when a user sings a song, the user can feel a music rhythm through a hand gripping the microphone. Also, a vibration can be provided such that a user can feel a song start signal. In addition, it can be evaluated to sing a song by providing a celebratory vibration when passed or providing a strong vibration when not passed, thereby doubling the joy.

In the present invention, the player further comprises a camera module installed in the housing, and the controller compresses a photograph image picked up through the camera and stores the compressed photograph image in the non-volatile storage unit in a photograph image file that is a kind of data files. Accordingly, it is possible to fabricate a music video or a music album by photographing a user and/or a participant when the user sings a song.

In the present invention, the player further comprises an FM transceiver unit, and the controller receives the voice data signal and the control data signal transmitted from an auxiliary wireless microphone through the FM transceiver unit, provides the received voice data signal to the audio codec, and displays a lyric data of the selected image music file on the liquid crystal display unit in response to the received control data signal.

In the present invention, the player further includes a television transmitter installed in the housing, wherein the controller transmits a composite image signal and an output audio signal as a television channel signal through the television transmitter.

In another aspect of the present invention, there is a video-song accompaniment apparatus including: a microphone case having a head part in which an external microphone is installed, a grip part having a coupling groove formed on an outer circumference thereof, and a microphone connection terminal, an audio line terminal and a video line terminal formed in the coupling groove; a portable moving picture multimedia player having a portable size, detachably coupled in the coupling groove of the microphone case, having a plurality of connection terminals formed on an outer circumference thereof to electrically contact the microphone connection terminal, the audio line terminal and the video line terminal, switching the external microphone and an internal microphone in response to coupling or decoupling of the portable moving picture multimedia player, the portable moving picture multimedia player operating in a video-song accompaniment mode when it is coupled, and operating in a portable multimedia player mode when it is decoupled.

In still another aspect of the present invention, there is provided a video-song accompaniment apparatus including: a microphone case having a microphone connection terminal, an audio line terminal and a video line terminal formed on a coupling groove thereof; an auxiliary wireless microphone including an FM transceiver unit and a user interface part, and transmitting a voice signal and a user command; and a portable moving picture multimedia player having a portable size, detachably coupled in the coupling groove of the microphone case, having a plurality of connection terminals formed on an outer circumference thereof to electrically contact the microphone connection terminal, the audio line terminal and the video line terminal, receiving an FM signal transmitted from the auxiliary wireless microphone to decode the voice signal and the user command, switching an external microphone and an internal microphone in response to coupling or decoupling of the portable moving picture multimedia player, the portable moving picture multimedia player operating in a video-song accompaniment mode when it is coupled, and operating in a portable multimedia player mode when it is decoupled.

Accordingly, when the auxiliary microphone is used, the portable moving picture multimedia player can be used as a lyric display. Also, it is possible that two users enjoy the video-song accompaniment in duet, one using the microphone case coupled with the portable moving picture multimedia player and the other using the auxiliary microphone.

The present invention enables to enjoy the video-song accompaniment only with the portable moving picture multimedia player, but is characterized in that the portable moving picture multimedia player is coupled with the microphone case such that users can feel an atmosphere singing a song with holding the microphone.

### ADVANTAGEOUS EFFECTS

According to the present invention, a microphone case and a portable moving picture multimedia player of a microphone-type video-song accompaniment apparatus are configured to be detachably coupled with each other, the accompaniment apparatus can be used as both the video-song accompaniment apparatus and the handheld music file player.

Also, since about 5000 song accompaniment music files and background picture files can be stored in the portable moving picture multimedia player, if the portable moving picture multimedia player is directly connected with a television without a settop box type accompaniment apparatus, it is possible to enjoy the background pictures along with the song accompaniment.

### DESCRIPTION OF DRAWINGS

FIG. 1 is a front exterior perspective view of a portable moving picture multimedia player according to a preferred embodiment of the present invention;

FIG. 2 is a rear exterior perspective view of a portable moving picture multimedia player according to a preferred embodiment of the present invention;

FIG. 3 is a front view of a portable moving picture multimedia player according to a preferred embodiment of the present invention when the portable moving picture multimedia player is mounted on a microphone case;

FIG. 4 is a side view of a portable moving picture multimedia player according to a preferred embodiment of the present invention when the portable moving picture multimedia player is mounted on a microphone case;

FIG. 5 is a block diagram of a portable moving picture multimedia player according to a preferred embodiment of the present invention;

FIG. 6 is a diagram illustrating the mapping state of a storage unit according to a preferred embodiment of the present invention;

FIG. 7 is a view illustrating a format structure of a video-song accompaniment music file according to the present invention;

FIGS. 8 to 10 are flow diagrams illustrating an operation of the microphone-type video-song accompaniment apparatus according to the present invention.

FIGS. 11 to 17 are diagrams illustrating operation pictures of the microphone-type picture song accompaniment apparatus according to the present invention.

### BEST MODE

Hereinafter, preferred embodiments of the present invention will be sufficiently described in detail with reference to the accompanying drawings such that those skilled in the art can practice the present invention.

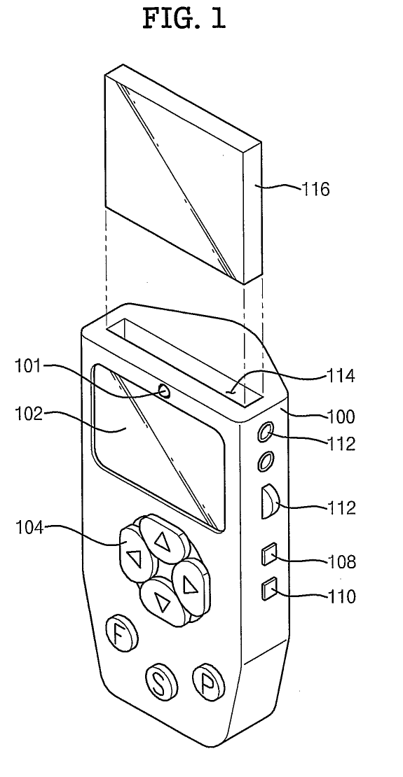

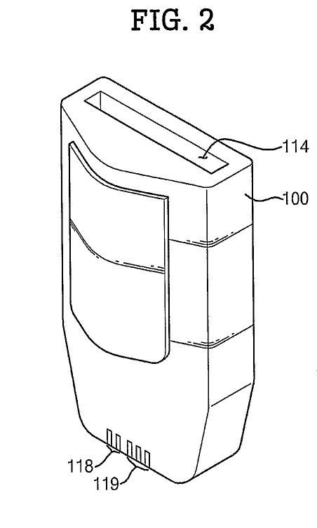

FIG. 1 shows a front exterior perspective view of a portable moving picture multimedia player according to a preferred embodiment of the present invention, and FIG. 2 shows a rear exterior perspective view.

Referring to FIG. 1, a housing 100 of a portable moving picture multimedia player has a ultra-miniaturized size of a pocket type or a handheld type. On a front side of the housing 100 are installed a camera 101, a liquid crystal display window 102, and directional key pads 104. The directional key pads 104 consist of four up, down, left and right directional keys.

The housing 100 includes a jog dial/button 106, a mode selection button 108, a play button 110 and a headphone jack 112 at the right side thereof. Also, the housing 100 includes a card slot 114 formed on an upper surface thereof, and a flash memory card 116 is inserted into and installed in the card slot 114.

Referring to FIG. 2, the housing 100 also includes a microphone connection terminal 118, and video and audio line connection terminals 119 at a bottom surface thereof.

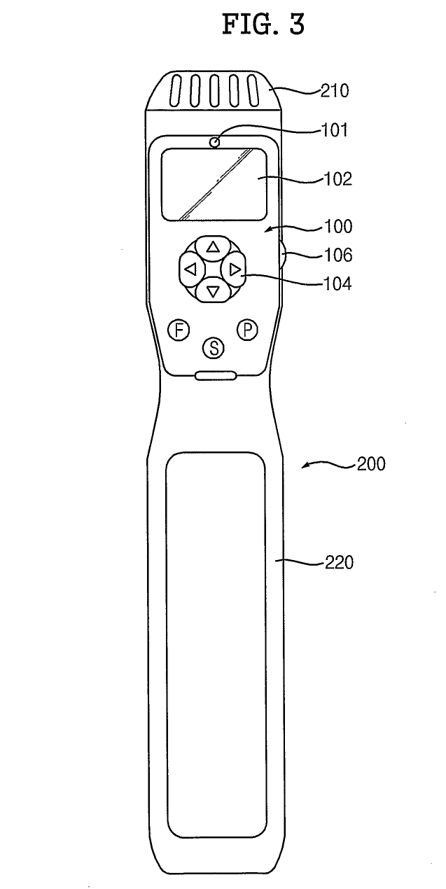

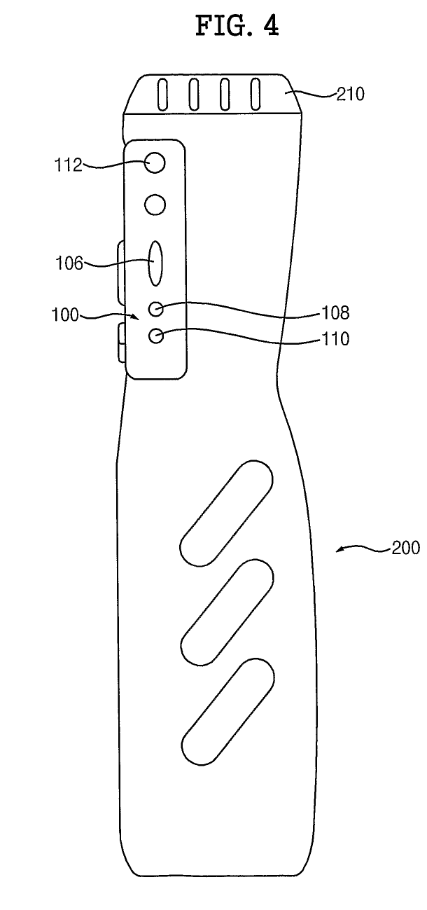

FIG. 3 is a front view of a portable moving picture multimedia player according to a preferred embodiment of the present invention when the portable moving picture multimedia player is mounted on a microphone case, and FIG. 4 is a side view thereof.

A microphone case 200 has a head part 210 where a microphone is built, and a grip part 220 having a groove formed at a top portion. The housing 100 of the portable moving picture multimedia player is detachably coupled in the groove. At an inner lower side of the groove of the microphone case 200, contact terminals electrically contacting the connection terminals of the bottom of the housing are formed. An AV cable is connected at a lower portion of the grip part 220, and a plug inserted into an audio input line jack and a video input line jack of a television is formed at one end of the cable. Accordingly, the portable moving picture multimedia player can be connected with the television in a wiring way or a wireless way.

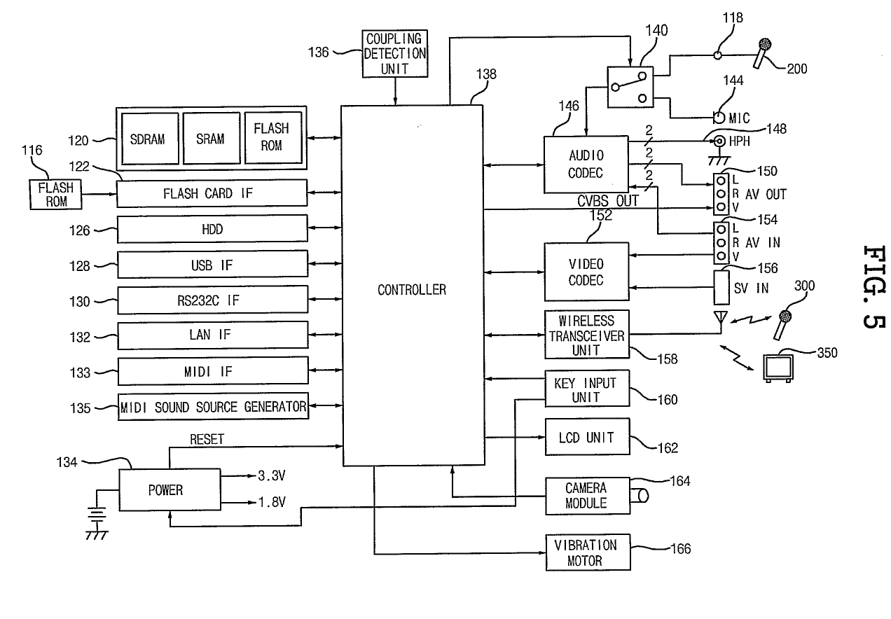

FIG. 5 is a block diagram of a portable moving picture multimedia player according to a preferred embodiment of the present invention.

Referring to FIG. 5, the portable moving picture multimedia player includes a main memory 120, a flash memory card interface 122, a flash memory card 124, a mini hard disc driver 126, a USB interface 128, an RS232C interface 130, a LAN interface 132, a MIDI interface 133, a MIDI sound source generator 135, a power 134, a coupling detection unit 136, a controller 138, a selection switch 140, a microphone contact terminal 142, an internal microphone 144, an audio codec 146, a headphone jack 148, an AV line output jack 150, a video codec 152, an AV line input jack 154, a super video input jack 156, a wireless transceiver unit 158, a key input unit 160, a liquid crystal display unit 162, a camera module 164, and a vibration motor 166.

The controller 138 uses a multimedia processor, which is mainly used in the field of a portable digital media application and made by TI Inc. The processor is one-chip processor including an ARM7 central processing part, a digital signal processing part, a memory controller, an OSD NTSC/PAL encoder, a digital camera interface, an image processing engine and a communication interface, such as a USB, UART, a serial interface. The controller 138 is programmed so as to execute a program for generating a video-song accompaniment music file according to the present invention and playing the generated video-song accompaniment music file.

The main memory 120 includes a synchronous DRAM having the size of 2M*16*4 bank, an SRAM having the size of 512*16, a flash memory having the size of 16 Mb and the like, and stores data through the memory controller of the controller 138.

The flash memory card interface 122 provides slots for a compact flash card, a memory stick, a smart media and the like, and stores data through the memory controller of the controller 138. In the present invention, video-song accompaniment music files, background picture files, computer files including MP3 files downloaded from a computer, voice recording files, photograph image files, etc., are stored in the flash memory card 116.

The mini hard disc driver 126 can be optionally used solely or in combination with the flash memory card 116. For example, the mini hard disc driver 126 can store moving picture files for the background picture files, MP3 files and the like.

The USB interface 128 and the LAN interface 132 download MP3 files from an external computer through the communication interface of the controller 138 or provide the voice files stored in the flash memory card to an uploading channel.

The RS232C interface 130 is provided as a serial communication port to enable to extend to various applications.

The MIDI interface 133 provides an interface for directly inputting MIDI data at an exterior. Accordingly, it is possible to directly input MIDI data into the portable moving picture multimedia player.

The MIDI sound source generator 135 generates sound source corresponding to the MIDI data inputted through the flash card or the MIDI interface.

The power 134 is supplied with a main power from 3.6 V charging battery, dry cell or the like to generate an inner power voltage, for example, 3.3 V, 1.8 V, etc. The power 134 generates a system reset signal in response to a reset switch to provide the generated system reset signal to the controller 138, and responds to a power key to turn on/off the power.

The coupling detection unit 136 provides a coupling detection signal to the controller 138 when the portable moving picture multimedia player 100 is coupled to the groove of the microphone case 200. For example, when the player is coupled, the coupling detection signal can be kept at a high level, and when the player is decoupled, the coupling detection signal can be kept at a low level.

The selection switch 140 selects an internal microphone 144 or an external microphone 200 in response to the coupling detection signal provided from the controller 138. The external microphone 200 is electrically connected with the portable moving picture multimedia player 100 through the microphone connection terminal 118.

The audio codec 146 may be a TLV320AIC23PW audio codec chip from TI. The audio codec 146 converts a stereo line input audio signal into a digital data, or converts a received digital audio data into an analog audio signal to generate a stereo line output and a stereo headphone output. Also, the audio codec 146 mixes an microphone input with a stereo line input or a stereo line output.

The stereo headphone output signal is outputted through the headphone jack 148. The stereo line output signals (L, R) are connected through the AV line output jack 150 to the external stereo audio output line. A composite video signal (CVBS) from the NTSC/PAL encoder of the controller 138 is applied to the AV line output jack 150 and connected to the external video output line. Therefore, each terminal of the AV line output jack 150 is electrically connected to a connection terminal in the coupling groove of the microphone case 200 when it is coupled thereto. The stereo audio signal inputted through the AV line input jack 154 is provided to the audio codec 146.

The video codec 152 may be an SAA7115 9-bit video codec chip from Philips. The video codec 152 receives an external video signal through the AV line input jack 154 or the super video jack 156, converts the received video signal into a digital video data, and provides the resulting digital video data to the controller 138.

The wireless (RF) transceiver unit 158 receives a signal transmitted from the auxiliary microphone 300 (e.g., an auxiliary microphone 300 disclosed in Korean Patent No. 10-0093362 entitled “Automatic accompanying apparatus-built in Microphone” and Korean Patent Publication No. 1997-68724 entitled “Microphone outputting images/song lyrics information and accompaniment”), detects a selected song signal from the received signal, and provides the detected signal to the controller 138.

Also, the wireless transceiver unit 158 receives a stereo audio signal and a composite video signal, modulates the signals into a television channel signal (e.g., a 12-channel or 14-channel television signal), and wirelessly transmits the television channel signal to the television receiver 350. Accordingly, when the wireless scheme is applied, the television channel is tuned to 12 or 14, the background video signal from the portable device 100 is displayed on the television screen, and the audio signal from the portable device 100 is outputted through the television speaker, enabling enjoyment of them.

The key input unit 160 is a user interface, and includes direction keys, a display key, a function key, a stop key, a jog dial, a mode selection key, and a play key. The LCD display unit 162 displays lyric characters provided from the controller 138.

The direction keys are used for moving menus and lists. The Up/Down direction keys are used for adjusting the volume of a song, and the Left/Right direction keys are used for adjusting the speed of a song. The Left direction key is used as a “reservation” button when a desired song is selected from the list.

The function key is used for displaying menus and functions on the screen, and the function is cancelled when the function key is pressed once again. When the function key is pressed for a long time, the power is turned on/off. The stop key is used for canceling a function, moving to the previous stage, stopping a song, or canceling a menu.

When the play key is pressed once again during the play of a song, a temporary stop function is performed. The play key is also used as an enter key for selecting an item at which the cursor is placed in the menu or the function.

The jog dial may be used for speeding a selected song up. When a song is selected by an up/down menu, a fast movement to the up/down menu can be performed by rotation of the jog dial. Also, the jog dial may be used for increasing or decreasing an adjustment value. When the button of the jog dial is pressed, an item at which the cursor is placed can be selected and the function and the adjustment value can be confirmed.

When the song number input mode is set by the mode selection key, the button of the jog dial can be pressed to move between digits. When the jog dial is rotated at the state of a designated digit, a corresponding number of the corresponding digit is scrolled and displayed. When a desired number is displayed and the jog dial is pressed, the corresponding number is set. In this manner, the song number can be rapidly inputted by moving between digits only the use of the jog dial.

When the song title selection mode is set by the mode selection key, a page of songs (e.g., 20 songs) are displayed on the screen. When the jog dial button is pressed, the next page is displayed. About 20 pages are displayed per page. A desired song can be selected by moving the cursor to a desired song title by rotation of the jog dial and selecting the cursor displaced at the desired song title. After the completion of the song selection, the play key is pressed to start the song accompaniment.

The camera module 164 converts an image picked up by the CMOS image sensor of a subminiature camera module into a picture signal and provides the picture signal to the controller 138. The controller 138 compresses the picture signal by the MPEG algorithm to create a photograph image file, and stores the photograph image file in the memory card 116. The photograph image taken by the camera module 164 may be viewed by a television, or may be vied by a computer display after uploading it to a computer through a computer interface.

The vibration motor 166 is driven under the control of the controller 138 to generate a specific vibration. For example, under the control of the controller 138, the vibration motor 166 may generate a vibration in synchronization with a song start count, may generate vibrations in accordance with a song's rhythm to transfer the generated vibrations to a user's hand by which the microphone case or the housing of the portable device is taken so as to enable the user to feel the song's rhythmical sense, or may generate vibrations corresponding to a failure or success in the sing of the user so as to enable the user to enjoy the song accompaniment.

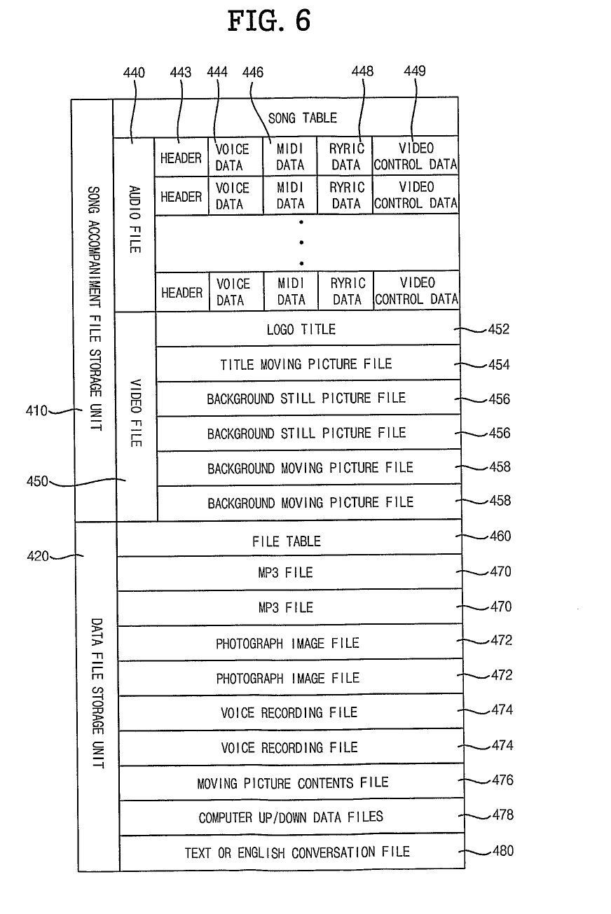

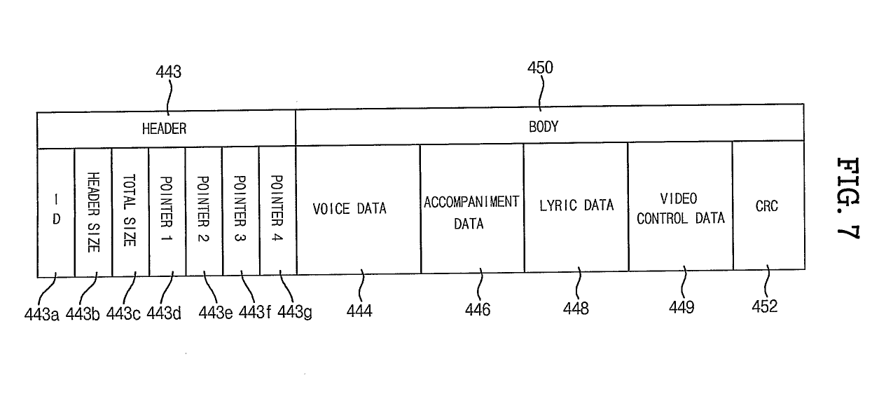

FIG. 6 is a diagram illustrating the mapping state of the storage unit according to an embodiment of the present invention.

Referring to FIG. 6, the storage unit includes a song accompaniment storage region 410 and a data file storage region 420. The song accompaniment storage region 410 is divided into a song table region 430, an audio file region 440, and a video file region 450.

A list of audio files and initial address values corresponding to the audio files are written in a table and the table is stored in the song table region 430. During selection of a song, a corresponding audio file is accessed with reference to the song table. Also, a list of video files and initial address values corresponding to the video files are written in a table and the table is stored in the corresponding region. When the system is booted, the tables in the song table region 430 are automatically accessed and loaded to the main memory 120 by the controller 138.

The video-song accompaniment files corresponding to the respective sons are stored in the audio file region 440. The respective video-song accompaniment files are stored with the size of about 350 to 450 KB according to their play time. FIG. 5 is a diagram illustrating a format of an audio file (i.e., a music file) according to an embodiment of the present invention.

Referring to FIG. 5, an audio file 442 includes a header 443, a body 450 having voice data 444, accompaniment data 446 and lyric data 448, and an error correction code 452.

The header 443 includes a header ID code 443a, a header size 443b, the total size 443c, pointer 1 443d, pointer 2 443e, pointer 3 443f, and pointer 4 443g. The pointer 1 443d, the pointer 2 443e, the pointer 3 443f, and the pointer 4 443g designate the initial addresses of the voice data 444, the accompaniment data 446, the lyric data 448, and the video control data 449, respectively.

The voice data 444 is a data that is obtained by compressing a voice signal of a singer. That is, the voice signal of a singer is converted into a 16-bit audio data at a sampling frequency of 22 KHz (704 Kbps=22 KHz 16 bit), and the resulting audio data is compressed into a data of about 12 Kbps by the compression algorithm of, for example, the audio standards G726 to G729. Accordingly, in the case of an about 4-minute song, the voice signal of a singer is compressed into a data of about 360 KB (=12 Kbps 240 sec/8 bit). Here, the compression algorithm for the audio data may be any algorithm within the same range.

The accompaniment data 446 is a data that is obtained by creating the instrument sounds of a song into a MIDI data and compressing the created MIDI data, wherein an about 4-minute MIDI data (for 16 channels (sixteentet)) has a data amount of 45 KB. The MIDI data is compressed to 13 KB by a no-loss compression algorithm, for example, ZIP and LHA.

Accordingly, the video-song accompaniment file per song includes voice/instrument data of about 373 KB, the lyric data 448, and the video control data 449, and thus has a data amount of about 400 KB. For example, 5000 songs occupy the storage space of 2 GB. Therefore, the video-song accompaniment file has 9 times the compression rate of an MP3 file and has 106 times the compression rate of an original signal. Since the existing flash memory has about 2 GB storage capacity, the present invention makes it possible to implement a portable multimedia device capable of storing 5000 songs.

The accompaniment data 446 is a MIDI data that includes a state byte of 1 byte and data bytes of one or more bytes. The accompaniment data is classified into a channel message and a system message according to the state byte. The channel message is sub-divided into a voice message and a mode message, and the system message is sub-divided into an excusive message, a command, and a real-time message. A note-on/off message indicates at which of 128 tones and several ten sound strengths a sound must be generated and stopped.

The lyric data 448 includes a character data for representing the lyric of a song in a caption.

The video control data are index order values of the background picture, and includes index values of several or several ten related background pictures corresponding to the contents of a lyric.

Accordingly, when a specific song is selected, the related background video pictures are sequentially accessed from the video file region 450 by the video control data of the related audio file 442 and then displayed on the screen.

Voice data, MIDI data, lyric data, and video control data are synchronized by a MIDI time code. Examples of the MIDI time code are a header frame message, a full time code message, a user bit message, and a setup message.

Referring FIG. 6, a video file region 450 includes an initial logo title still picture 452, a title moving picture file 454, thousands of background still picture files, and tens to hundreds of background moving picture files 458.

Background picture files include moving picture files and still picture files. Preferably, a moving picture is constructed by a moving picture file with 512-Kbps data, which is obtained by applying a MPEG4 compression scheme to RGB color data with 720×480 pixels per screen.

For example, the size of the moving picture file of about one minute may be about 3.8 MB. A still picture has 40-KB data according to the MPEG4 compression scheme. Accordingly, when the background picture files include about 100 moving picture files of about one minute and about 1000 still picture files, it requires a storage space of about 420 MB (=380 MB+40 MB). Therefore, the size of the storage space may be properly designed by the combination of thousands of background picture files and thousands of picture song accompaniment files.

For example, when the moving picture song accompaniment apparatus includes picture song accompaniment files of 3000 songs, 100 moving picture files each having a play time of one minute, and 1000 still picture files, about 1.62 GB total storage space is required. Therefore, when the storage space is implemented using a 2 GB flash card, the player has about 380 MB marginal storage space.

Here, the background pictures may be classified by seasons (spring/summer/autumn/winter), moods (ballad/dance/disco/jazz/funky), and ages (teenage/twenties/thirties/forties).

Therefore, the video control data may include classification codes for background pictures or access codes for specific background files, and a control operation may be performed such that a specific background of a corresponding timing or a background file of a corresponding classification may be selected and accessed randomly. Therefore, a variety of background pictures can be implemented using only background pictures less than the number of songs.

Referring to FIG. 6, a data file storage unit 420 may store a file table 460, MP3 files 470, picture image files 472, voice recording files 474, moving picture contents files 476 downloaded from a computer, computer up/down data files 478, and text or English conversation files 480.

The file table 460 may include index data of the voice recording files and the MP3 files. The MP3 files 470 may be stored in the size of 3 to 5 MB, and the voice recording files 480 may be stored in the different file sizes according to various sampling frequencies of 4 KHz, 8 KHz, 9.6 KHz, 16 KHz, 22 KHz, 36 KHz, 44.1 KHz, etc.

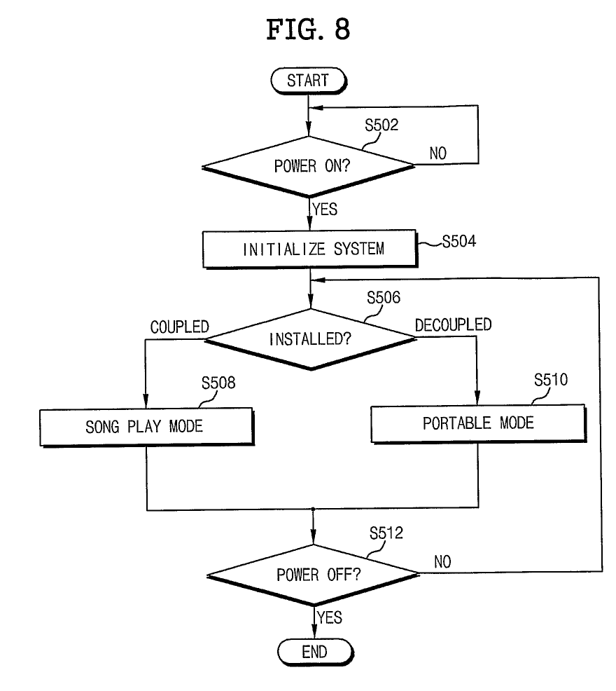

FIGS. 8 to 10 are flow diagrams illustrating an operation of the microphone-type video-song accompaniment apparatus according to the present invention.

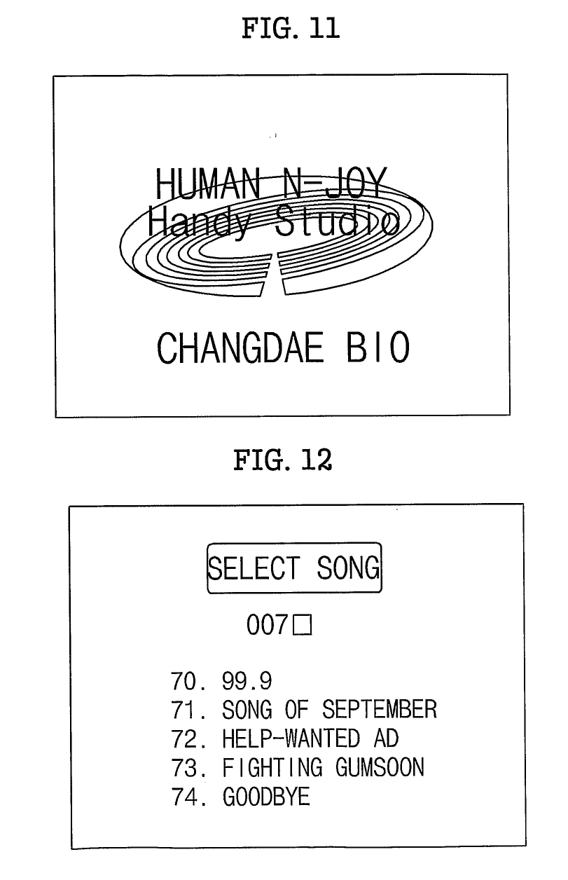

FIGS. 11 to 17 are diagrams illustrating operation pictures of the microphone-type picture song accompaniment apparatus according to the present invention.

Referring to FIG. 8, in step S502, the power is turned on by pressing a function key for a long time (e.g., about two seconds). In step S504, the controller 228 receives a reset signal and initializes the system. At this time, the tables of the flash memory card 116 is accessed and stored in the main memory 120. In step S506, the installation detector 136 detects whether or not the portable device 100 is installed in the microphone case 200.

When the portable device 100 is installed in the microphone case 200, a song play mode routine is performed in step 508. On the contrary, when the portable device 100 in not installed in the microphone case 200, a portable mode routine is performed in step S510. Thereafter, whether or not the power is turned off is checked in step S512. When the power is turned off, the operation is ended. On the contrary, when the power is not turned off, the operation returns to step S506.

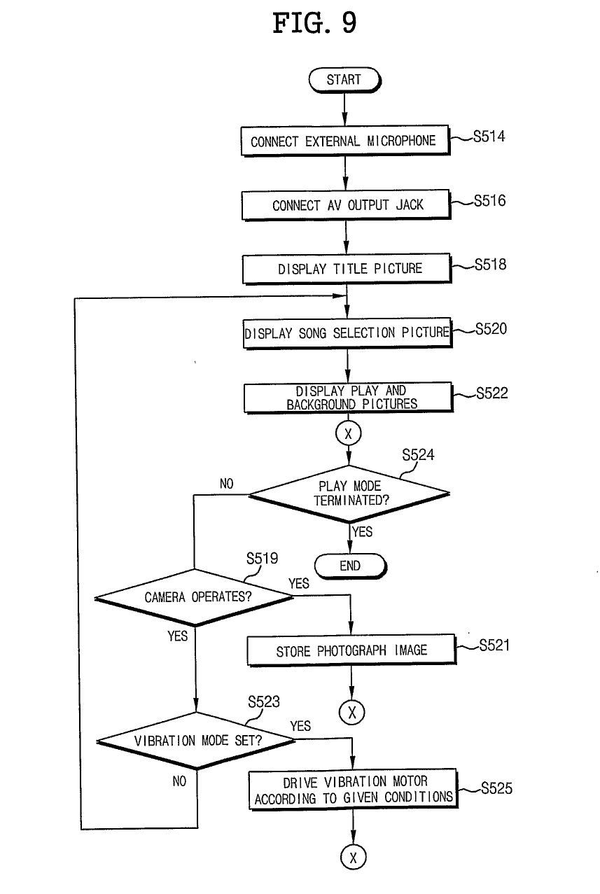

Referring to FIG. 9, when portable microphone 100 is installed in the microphone case 200, the controller 138 switches, in step S514, the microphone selector 140 such that the external microphone 200 is connected to the audio codec 146. In step S516, the audio codec 146 and the video codec 152 are enabled such that the external audio and video lines are connected to the internal circuit by the AV output jack 150.

In step S518, the controller 138 reads a still title picture from the storage unit and outputs the still title picture in a composite video signal to display a logo on a screen of the television 350 (see FIG. 11) and display a moving picture title for about five second. When a key input is generated during the display of the moving picture title, a song selection picture (see FIG. 12) is displayed in step 520. Here, the compressed video data is expanded by the controller 138 and the extended video data is converted into an analog video signal such that a sync signal is overlapped to output the read-out picture data in the composite video signal (CVBS).

When the song selection picture is displayed on the screen, a song number is inputted to select a desired song. A number at a cursor position is changed by pressing UP/DOWN direction keys or by using a jog dial. When the changed number is correct, a RIGHT direction key or the jog dial is pressed to decide the input. Thereafter, the cursor moves to the next position and flickers for input of the next number.

After a four or five-digit song selection number is decided as above, and a play key is pressed to start the song play.

If an incorrect number is inputted, a LEFT direction key is pressed to delete the incorrect number so as to input a correct number.

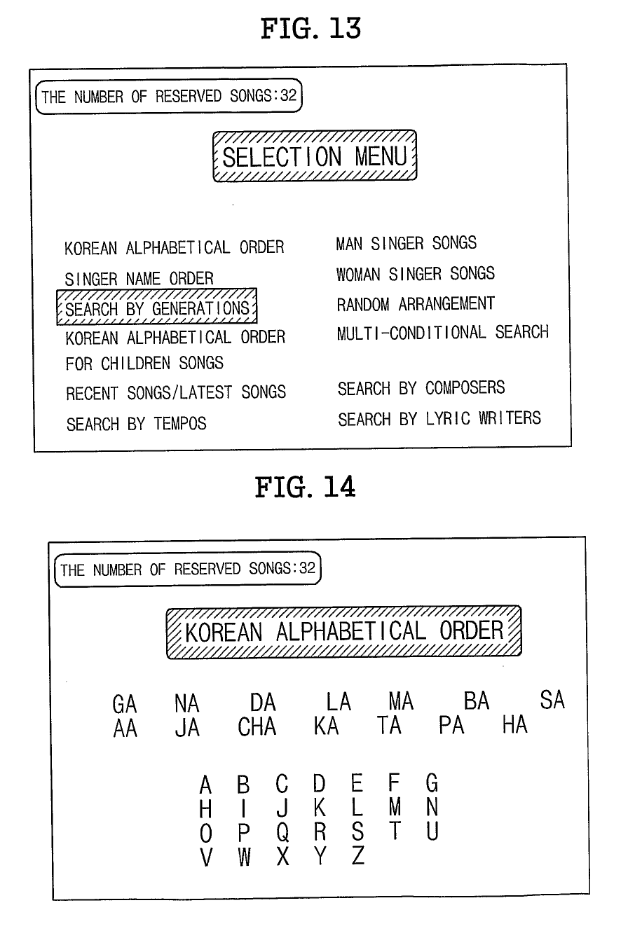

When the function key is inputted, a variety of song selection menus are displayed as illustrated in FIG. 13.

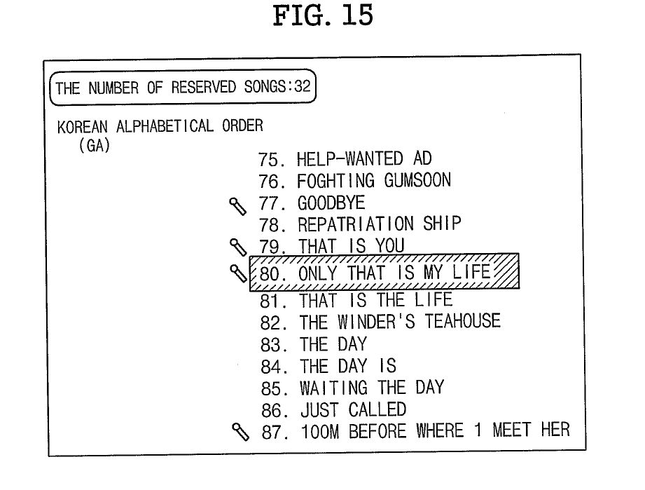

The song selection menus may include Korean Alphabetical Order, Man Singer Songs, Singer Name Order, Woman Singer Songs, Search by Generations, Random Arrangement, Korean Alphabetical Order for Children Songs, Multi-conditional Search, Recent Songs/Latest Songs, Search by Composers, Search by Tempos, and Search by Lyric Writers. In the case of Korean Alphabetical Order, song titles are displayed in the Korean alphabetical order, the cursor is moved to select a desired song title, and the display key is pressed to start the play of the selected song. In the case of Singer Name Order, singer names are displayed in the Korean alphabetical order for selection of a desired song. In the case of Search by Generations, one generation list of the 1960's/the 1970's/the 1980's/the 1990's/2000's or later/the latest songs is selected and the cursor is moved among the corresponding arranged items to select a desired song. In the case of Korean Alphabetical Order for Children Songs, children songs are displayed in the Korean alphabetical order and a desired song is selected. In the case of Recent Songs, songs within the previous two years are displayed in the Korean alphabetical order and a desired song is selected. In the case of Latest Songs, songs within the previous six or three months are displayed in the Korean alphabetical order and a desired song is selected. In the case of Search by Tempos, one list of slow songs, medium tempo songs, swinging songs, fast song is selected, the corresponding song items are displayed in the Korean alphabetical order, and a desired song is selected. In the case of Multi-conditional Search, an initial song selection menu is selected and then another song selection menu is selected to select a desired song. When the Korean alphabetical order menu is selected, the Korean alphabetical order menu is displayed as illustrated in FIG. 14. When the cursor is placed at a desired item in a sub-menu picture and then the enter key is pressed, the corresponding song titles are sequentially displayed. The displayed song titles are scrolled by the UP/DOWN direction keys or the jog dial to search a desired song title.

As illustrated in FIG. 15, when the cursor is placed on the selected item and then the LEFT direction key is pressed, a reservation mark is displayed and a selected song is reserved. The number of the currently-reserved songs is displayed on the upper left portion of the screen.

When a desired song appears during the selection of a song, the RIGHT direction key can be pressed to register the desired song as user's favorite song. The management of favorite songs may be performed for up to 10 users.

When the desired song is selected, the controller 138 reads the selected picture song accompaniment file from the flash memory card 116 to store the selected file in the main memory 120, and reads the pointer value of a file header to separately store the voice data, the MIDI data, the lyric data, and the video control data.

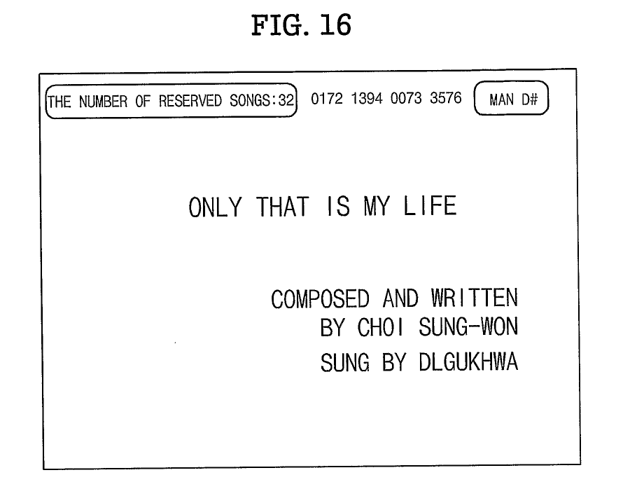

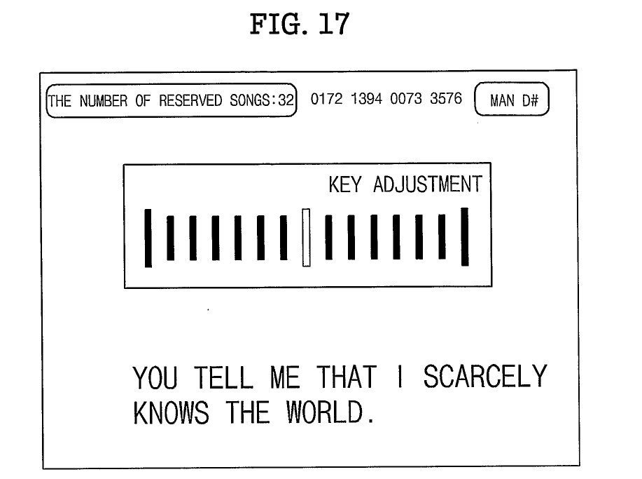

When the START key is pressed, the selected song is played in step S522. At this time, the reserved song numbers, the title of the song, and the names of the lyric writer, composer and singer are displayed on the screen as illustrated in FIG. 16. When the LEFT/RIGHT direction keys are pressed during the play of the song, the play speed is adjusted. When the adjustment is completed, the displayed menu disappears by pressing of the function key or after three seconds. When the UP/DOWN direction keys are pressed during the play of the song, a key (tone) adjustment menu picture is displayed as illustrated in FIG. 17, enabling the adjustment of the key tone. During the play of the song, the function key may be pressed to perform menu functions, such as, Man/Woman, Volume, Echo, Reverse adjustment, Selected menu, Registers (soprano/alto/tenor/bass), Melody-Off (only an accompaniment is played), Lyric-Off (sing a song without viewing a lyric), and Instrument Change. The menu functions may further include repeated play of a song, change of a background picture, and a song game.

During the performance of the MIDI data, the controller 138 outputs instrument sounds and voice signals in synchronization with a timing signal, and concurrently superimposes, by referring to the video control data, a background file and lyric data to display a background picture signal together with the lyric.

Thereafter, whether or not the play mode is terminated is determined in step S524. If the play mode is terminated, the operation returns to the main program, and if not, the operation proceeds to step S519. In step S519, whether the camera operates or not is determined. If the camera operates, the operation proceeds to step S521, and if not, the operation proceeds to step S523. In step S521, a photographed image is stored. In step S523, whether or not a vibration mode is set is determined. If the vibration mode is set, the operation proceeds to step S525, and if not, the operation returns to step S520. In step S525, a vibration motor is driven according to predetermined conditions.

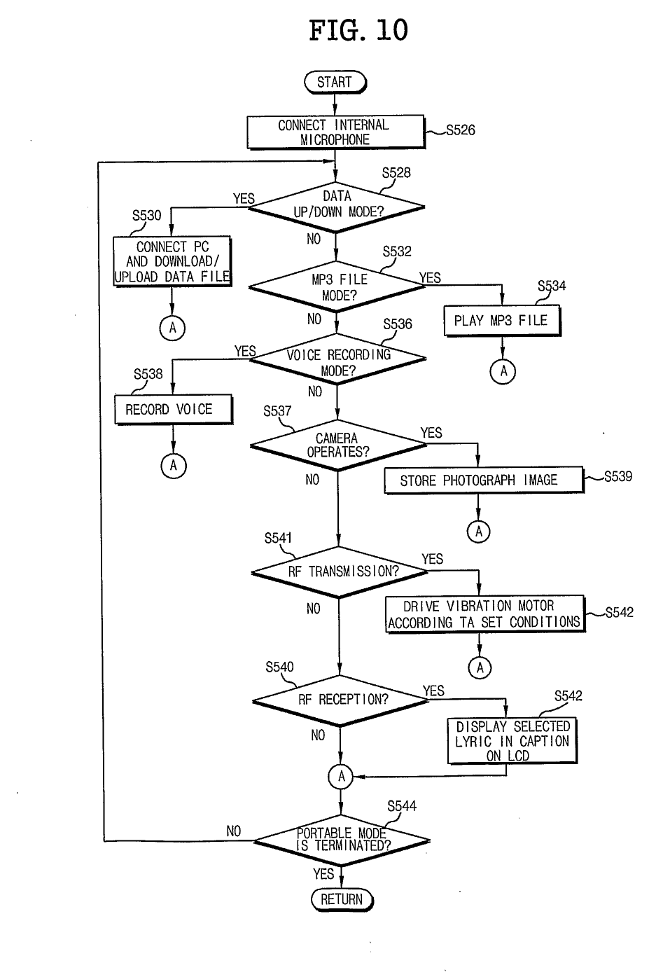

The portable mode routine of step S510 will now be described in detail with reference to FIG. 10.

Referring to FIG. 10, in step S526, the controller 138 controls the microphone selector 140 such that the internal microphone 144 is connected to the audio codec 146.

The controller 138 sequentially checks a data up/down mode (step S528), an MP3 file select mode (step S532), a voice recording mode (step S536), and an RF reception mode (step S540). When the data un/down mode is set in step S528, a computer data file (e.g., the MP3 file) is downloaded to the portable device 100 through a personal computer, a USB interface or an LABN interface in step S530. The downloaded MP3 file is provided through the controller 138 to the flash memory card interface 122 and stored in the flash memory card.

When the MP3 selection mode is selected in step S532, the controller 138 accesses the selected MP3 file with reference to the file table, and expands the accessed MP3 file, provides the expanded file to the audio codec 146. In step S534, the audio codec 146 converts digital audio data into analog stereo audio signals, and outputs the resulting analog signals to a headphone or an earphone through the headphone jack 148.

When the voice recording mode is set in step S536, voice signals inputted through the internal microphone 144 are converted into digital audio data by a given sampling frequency at the audio codec 146, the resulting voice data are created into a voice recording file by the controller 138, and the created voice recording file is stored in the flash memory card 116 (step S538).

When the voice recording mode is not set in step S536, whether or not the camera operates is determined in step S537 and a pickup image is stored in a photograph image file in step S539.

When the camera does not operate in step S537, RF transmission is checked in step S541. When the RF transmission is checked, the background picture image and the audio signal are modulated into television signals and transmitted wirelessly (step S542), because it is a song play mode.

When the RF signal transmitted from the auxiliary microphone 300 is received by the transceiver unit 158 in step S540, the controller 138 executes the received command to access the lyric data of the corresponding song and display the lyric on the liquid crystal display unit 162 in the form of a caption. Accordingly, it can be used as a captioning unit for the lyric of a song.

If the operation is terminated in step S530, S534, S538 or S542, or if the RF signal is not received in step S540, the operation proceeds to step S544. In step S544, whether or not the portable mode is terminated is determined. If the portable mode is terminated, the operation returns to the main program, and if not, the operation returns to step S528.

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

As described above, the portable device and the microphone case are detachably constructed in the microphone-type video-song accompaniment apparatus, and thus it can be used as a video-song accompaniment apparatus or a portable music file player.

Also, about five thousand music files and the corresponding background video files can be stored in the portable device. Accordingly, when the portable device is directly connected to, for example, a TV, the song accompaniment and the background video can be simultaneously enjoyed without using a settop box type song accompaniment apparatus.

1. A portable moving picture multimedia player comprising:
a housing detachable in a microphone case and having a portable size;
an internal microphone built in the housing;
a plurality of connection terminals installed on an outer circumference of the housing so as to be electrically connected with an external microphone, an audio line and a video line installed in the microphone case;
a liquid crystal display unit installed at a front side of the housing, for displaying lyric information of selected songs and menu information;
a user interface for inputting a user command;
a computer interface installed in the housing, for interfacing uploading/downloading of data to/from a computer; a non-volatile storage unit installed in the housing, and having a storage space for storing a few thousands of compressed video music files and compressed background picture files and storing data file downloaded or provided from the computer or an exterior;
an audio codec installed in the housing, for converting input audio data into an analog audio signal, mixing the converted audio signal with a voice signal inputted through the external or internal microphone to create an output audio signal, and converting the input voice signal into a digital audio data;
a video codec installed in the housing, for creating a television complex video signal from an input video data and a caption data and a video data from an input video signal; and
a controller installed in the housing, for detecting whether the microphone case is coupled or decoupled to control a switching of the external and internal microphones, when the microphone case is coupled, the controller accessing a video music file selected from the non-volatile storage unit in response to a user command and decompressing the compressed audio data and providing the decompressed video music file to the audio codec, decompressing the compressed background picture and providing the decompressed background picture to the video codec to execute a video music accompaniment mode, when the microphone case is decoupled, the controller executing a video music accompaniment play mode, a computer data play/record mode and a computer data up/down mode.

2. The portable moving picture multimedia player of claim 1, wherein the compressed video music files comprise:
a voice data that a voice of a singer corresponding to the music is converted into a digital data and compressed;
an accompaniment data that sounds of musical instruments for the music are created in MIDI data and compressed;
a lyric data; and
a video control data for accessing the background pictures related with the lyric, atmosphere and genre of the music.

3. The portable moving picture multimedia player of claim 2, wherein the compressed video music files have a size corresponding to a few hundreds of kB.

4. The portable moving picture multimedia player of claim 2, wherein the data file is one selected from the group consisting of an MP3 music file, a voice recording file, a moving picture file and a combination thereof.

5. The portable moving picture multimedia player of claim 2, wherein the data file is one selected from the group consisting of an MP3 music file, a voice recording file, a moving picture file, a photograph image file, a text data and a combination thereof.

6. The portable moving picture multimedia player of claim 1, wherein the non-volatile storage unit is one selected from the group consisting of an EEPROM, a flash memory, a flash memory card, a mini hard disc driver and a combination thereof.

7. The portable moving picture multimedia player of claim 1, wherein the computer interface is one selected from the group consisting of a USB interface, an LAN interface and a combination thereof.

8. The portable moving picture multimedia player of claim 1, wherein the user interface comprises:
a directional key installed in the housing;
a jog dial installed in the housing and having a dial and a pushing button combined with the dial;
a mode selection key for selecting a song selection menu mode; and
a play key for starting or stopping a selected song, wherein when the song selection menu mode is selected by the mode selection key, a song number is scrolled and displayed, when a song title list selection menu mode is selected, desired songs are rapidly selected by moving a cursor on the title list displayed by an up/down dialing of the jog dial.

9. The portable moving picture multimedia player of claim 8, wherein the pushing button of the jog dial allows the cursor to be moved along digit positions of a song number whenever the pushing button is pushed in the song number selection menu mode, and allows pages of a title list to be converted whenever the pushing button is pushed in the song title list selection menu mode.

10. The portable moving picture multimedia player of claim 1, wherein the player further comprises a vibration motor installed in the housing, and the controller controls the vibration motor such that the housing vibrates in response to a rhythm of a selected song accompaniment.

11. The portable moving picture multimedia player of claim 1, wherein the player further comprises a camera module installed in the housing, and the controller compresses a photograph image picked up through the camera and stores the compressed photograph image in the non-volatile storage unit in a photograph image file that is a kind of data files.

12. The portable moving picture multimedia player of claim 1, wherein the player further comprises an FM transceiver unit, and the controller receives the voice data signal and the control data signal transmitted from an auxiliary wireless microphone through the FM transceiver unit, provides the received voice data signal to the audio codec, and displays a lyric data of the selected image music file on the liquid crystal display unit in response to the received control data signal.

13. The portable moving picture multimedia player of claim 1, further comprising a television transmitter installed in the housing, wherein the controller transmits a composite image signal and an output audio signal as a television channel signal through the television transmitter.

14. A microphone-type video-song accompaniment apparatus comprising:
a microphone case having a head part in which an external microphone is installed, a grip part having a coupling groove formed on an outer circumference thereof, and a microphone connection terminal, an audio line terminal and a video line terminal formed in the coupling groove;
a portable moving picture multimedia player having a portable size, detachably coupled in the coupling groove of the microphone case, having a plurality of connection terminals formed on an outer circumference thereof to electrically contact the microphone connection terminal, the audio line terminal and the video line terminal, switching the external microphone and an internal microphone in response to coupling or decoupling of the portable moving picture multimedia player, the portable moving picture multimedia player operating in a video-song accompaniment mode when it is coupled, and operating in a portable multimedia player mode when it is decoupled.

15. A microphone-type video-song accompaniment apparatus comprising:
a microphone case having a microphone connection terminal, an audio line terminal and a video line terminal formed on a coupling groove thereof;
an auxiliary wireless microphone including an FM transceiver unit and a user interface part, and transmitting a voice signal and a user command; and
a portable moving picture multimedia player having a portable size, detachably coupled in the coupling groove of the microphone case, having a plurality of connection terminals formed on an outer circumference thereof to electrically contact the microphone connection terminal, the audio line terminal and the video line terminal, receiving an FM signal transmitted from the auxiliary wireless microphone to decode the voice signal and the user command, switching an external microphone and an internal microphone in response to coupling or decoupling of the portable moving picture multimedia player, the portable moving picture multimedia player operating in a video-song accompaniment mode when it is coupled, and operating in a portable multimedia player mode when it is decoupled.
